(19) United States
(12) Patent Application Publication
(10) Pub. No.: US 2024/0265235 A1
(43) Pub. Date: Aug. 8, 2024

(54) RNN TRAINING APPARATUS, RNN TRAINING METHOD, AND STORAGE MEDIUM

(71) Applicant: KABUSHIKI KAISHA TOSHIBA, Tokyo (JP)

(72) Inventor: Ryuji SAKAI, Hanno Saitama (JP)

(73) Assignee: KABUSHIKI KAISHA TOSHIBA, Tokyo (JP)

(21) Appl. No.: 18/240,659

(22) Filed: Aug. 31, 2023

(30) Foreign Application Priority Data
Feb. 2, 2023 (JP) 2023-014633

(51) Int. Cl. G06N 3/044; G06N 3/08

(52) U.S. Cl. CPC G06N 3/044; G06N 3/08

(57) ABSTRACT

The RNN training apparatus includes a storage and processing circuitry. The storage stores a hidden state of an RNN for the N sequences. The processing circuitry selects M (M<N) sequences from N sequences used for training of the RNN to construct a mini-batch and outputs sequence information identifying the selected sequence. The processing circuitry reads the unprocessed hidden state of the sequence corresponding to the sequence information from the storage according to the sequence information. The processing circuitry optimize the RNN based on the unprocessed hidden state and the mini-batch. The processing circuitry writes the processed hidden state obtained by the optimization, in the storage according to the sequence information.

### CROSS-REFERENCE TO RELATED APPLICATIONS

This application is based upon and claims the benefit of priority from Japanese Patent Application No. 2023-014633, filed Feb. 2, 2023, the entire contents of which are incorporated herein by reference.

### FIELD

Embodiments described herein relate generally to an RNN training apparatus, a method, and a storage medium BACKGROUND

There is a method of constructing mini-batches from time-series data with various sequence lengths and training a recurrent neural network (RNN) in units of mini-batches. In the RNN, there is a technique called truncated back propagation through time (TBPTT). In the TBPTT, the sequence data is not subjected to error back propagation in the temporal direction without limitation in the training of the RNN, but is subjected to error back propagation in units of blocks cut out in time steps (for example, 128 or the like) of a fixed length.

In the RNN, it is necessary to train the RNN by constructing a mini-batch while ensuring continuity of time-series by taking over a hidden state or the like. In addition, in the training of the deep neural network, it is necessary to shuffle the time-series data supplied to the RNN in order to avoid data bias. In the training of the RNN by the time-series data in units of mini-batches, if shuffling is performed with blocks divided by the TBPTT, continuity of a hidden state that should be propagated beyond the TBPTT is interrupted. For this reason, in the training of the RNN by the time-series data in units of mini-batches by the TBPTT, in a case where the continuity of the hidden state is to be secured, the degree of freedom in selecting the time-series data constituting the mini-batch is reduced, the time-series data supplied to the RNN is biased, and the convergence of the training is unstable and the efficiency is deteriorated.

### BRIEF DESCRIPTION OF THE DRAWINGS

FIG. 1 is a diagram illustrating a configuration example of an RNN training apparatus according to the present embodiment.

FIG. 2 is a diagram illustrating an exemplary structure of sequence data.

FIG. 3 is a diagram illustrating an example of a processing procedure of RNN training processing.

FIG. 4 is a diagram illustrating an exemplary functional configuration of RNN training processing illustrated in FIG. 3.

FIG. 5 is a diagram illustrating an example of a mini-batch construction process.

FIG. 6 is a diagram schematically illustrating forward propagation calculation in optimization calculation.

FIG. 7 is a diagram illustrating a processing procedure of Example 1 from a mini-batch initialization process (step SA2) to a mini-batch presence/absence determination process (step SA4) illustrated in FIG. 3.

FIG. 8 is a diagram illustrating a processing procedure of Example 2 from a mini-batch initialization process (step SA2) to a mini-batch presence/absence determination process (step SA4) illustrated in FIG. 3.

FIG. 9 is a diagram illustrating a processing procedure of Example 3 from a mini-batch initialization process (step SA2) to a mini-batch presence/absence determination process (step SA4) illustrated in FIG. 3.

FIG. 10 is a diagram schematically illustrating an RNN used for effect verification according to the present embodiment.

FIG. 11 is a diagram illustrating a test score in a case where the batch size is 16.

FIG. 12 is a diagram illustrating a test score in a case where the batch size is 24.

FIG. 13 is a diagram schematically illustrating an RNN according to the modification.

FIG. 14 is a diagram illustrating a method according to a comparative example.

### DETAILED DESCRIPTION

The RNN training apparatus according to the embodiment includes a storage unit, a construction unit, a reading unit, an optimization unit, and a writing unit. The storage unit stores a hidden state that is intermediate output data of the recurrent neural network for the N sequences. The construction unit selects data of M sequences from data of N sequences used for training of the recurrent neural network to construct a mini-batch where M is smaller than N and outputs sequence information identifying the selected sequence. The reading unit reads the unprocessed hidden state of the sequence corresponding to the sequence information from the storage unit according to the sequence information. The optimization unit executes optimization calculation of the recurrent neural network based on the unprocessed hidden state and the mini-batch. The writing unit writes the processed hidden state, which is the intermediate output data of the recurrent neural network obtained by the optimization calculation, in the storage unit according to the sequence information.

Hereinafter, an RNN training apparatus, a method, and a program according to the present embodiment will be described with reference to the drawings.

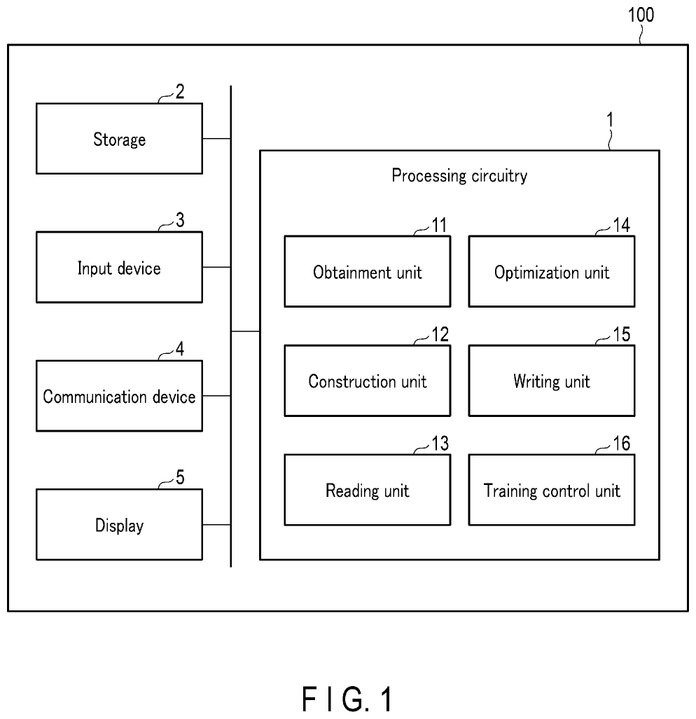

FIG. 1 is a diagram illustrating a configuration example of an RNN training apparatus 100 according to the present embodiment. As illustrated in FIG. 1, the RNN training apparatus 100 is a computer including a processing circuitry 1, a storage 2, an input device 3, a communication device 4, and a display 5. Data communication between the processing circuitry 1, the storage 2, the input device 3, the communication device 4, and the display 5 is performed via a bus. The RNN training apparatus 100 trains a recurrent neural network (RNN).

The processing circuitry 1 includes a processor such as a central processing unit (CPU) and a memory such as a random access memory (RAM). The processing circuitry 1 includes an obtainment unit 11, a construction unit 12, a reading unit 13, an optimization unit 14, a writing unit 15, and a training control unit 16. The processing circuitry 1 implements each function of the respective units 11 to 16 by executing the RNN training program. The RNN training program is stored in a non-transitory computer-readable storage medium such as the storage 2. The RNN training program may be implemented as a single program that describes all the functions of the respective units 11 to 16 described above, or may be implemented as a plurality of modules divided into several functional units. Each of the respective units 11 to 16 may be implemented by an integrated circuit such as an application specific integrated circuit (ASIC). In this case, it may be mounted on a single integrated circuit or may be individually mounted on a plurality of integrated circuits.

The obtainment unit 11 obtains data of N sequences (hereinafter, sequence data) used for training the RNN. The sequence data includes a plurality of elements following an any rule. Examples of the sequence data according to the present embodiment include time-series data including a plurality of elements along a time-series, linguistic data including a plurality of elements along a word order, and the like. The time-series data is, for example, data having a plurality of measurement values continuously output from various measuring instruments as elements. The linguistic data is data having a plurality of words disposed in a word order as elements.

The construction unit 12 selects M (natural number) sequences from N pieces of sequence data used for training of the RNN to construct a mini-batch where M is smaller than N and outputs sequence information identifying the selected sequence. The number M of sequences constituting each mini-batch is referred to as a mini-batch size. As the sequence information, an identifier that uniquely identifies the sequence is used.

The reading unit 13 reads an unprocessed hidden state of the sequence corresponding to the sequence information from the storage 2 according to the sequence information. The reading of the unprocessed hidden state is performed before the optimization calculation by the optimization unit 14. The hidden state means intermediate output data from the RNN based on the sequence data. The unprocessed hidden state means a hidden state used for the optimization calculation of the optimization unit 14.

The optimization unit 14 executes optimization calculation of the RNN based on the unprocessed hidden state and the mini-batch. In the optimization calculation, the optimization unit 14 performs forward propagation calculation, back propagation calculation, and parameter update. In the forward propagation calculation and/or the back propagation calculation, the optimization unit 14 calculates a processed hidden state. The processed hidden state means a hidden state obtained by the optimization calculation.

The writing unit 15 writes the processed hidden state, which is the intermediate output data of the RNN obtained by the optimization calculation, in the storage 2 according to the sequence information.

The training control unit 16 controls the training processing of the RNN. The training control unit 16 determines whether the update end condition is satisfied, and controls the obtainment unit 11, the construction unit 12, the reading unit 13, the optimization unit 14, and the writing unit 15 to repeat the training processing until it is determined that the update end condition is satisfied. In a case where it is determined that the update end condition is satisfied, the training control unit 16 ends the training processing.

The storage 2 includes a read only memory (ROM), a hard disk drive (HDD), a solid state drive (SSD), an integrated circuit storage apparatus, and the like. The storage 2 stores an RNN training program and the like. In addition, the storage 2 stores the hidden state for the N sequences in a readable/writable manner.

The input device 3 receives various types of commands from the user. As the input device 3, a keyboard, a mouse, various switches, a touch pad, a touch panel display, and the like can be used. An output signal from the input device 3 is supplied to the processing circuitry 1. Note that the input device 3 may be an input device of a computer connected to the processing circuitry 1 in a wired or wireless manner.

The communication device 4 is an interface for performing data communication with an external apparatus connected to the RNN training apparatus 100 via a network.

The display 5 displays various types of information. As the display 5, a cathode-ray tube (CRT) display, a liquid crystal display, an organic electro luminescence (EL) display, a light-emitting diode (LED) display, a plasma display, or any other displays known in the art can be appropriately used. The display 5 may be a projector.

Hereinafter, an operation example of the RNN training apparatus 100 according to the present embodiment will be described.

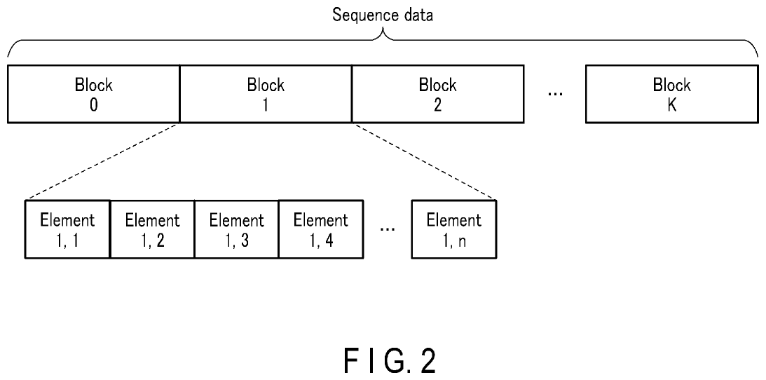

First, the structure of the sequence data according to the present embodiment will be described with reference to FIG. 2. FIG. 2 is a diagram illustrating an exemplary structure of sequence data. As illustrated in FIG. 2, the sequence data includes a plurality of elements following to an any rule. The plurality of elements is divided into K (natural number) blocks. Each block includes n (natural number) elements following an any rule. The number n of elements included in each block has a fixed value called a TBPTT length regardless of the block. That is, the sequence lengths of the K blocks are the same. The sequence data includes K×n elements. The division of the sequence data into K blocks may be performed by the construction unit 12, or the obtainment unit 11 may obtain the sequence data divided into K blocks. Note that the number of blocks of each sequence data may be the same or different for each sequence.

Next, the RNN training processing by the RNN training apparatus 100 according to the present embodiment will be described.

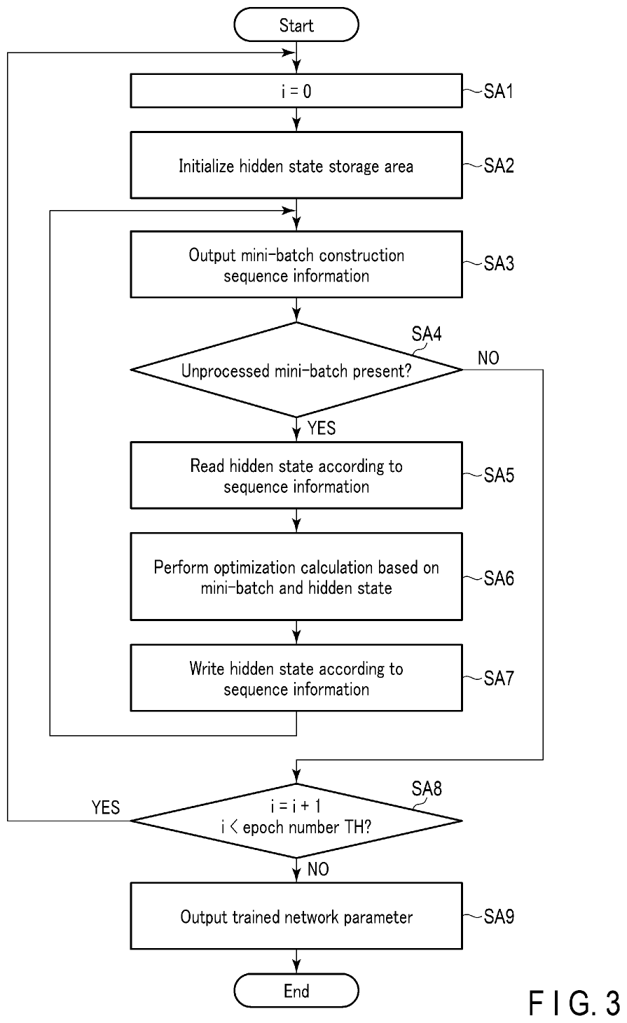

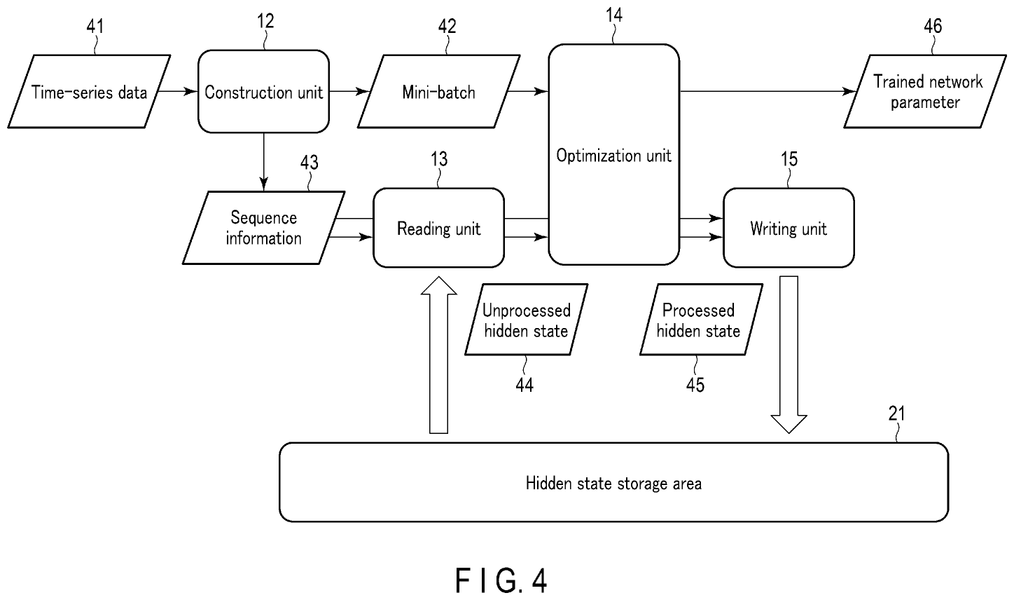

FIG. 3 is a diagram illustrating an example of a processing procedure of the RNN training processing. FIG. 4 is a diagram illustrating a functional configuration example of the RNN training processing illustrated in FIG. 3. Note that it is assumed that N pieces of time-series data have already been obtained by the obtainment unit 11 at the start time point of FIG. 3.

First, the training control unit 16 sets the index i to the value “0” (step SA1). The index i is a variable representing the epoch number for determining an update end condition.

In a case where step SA1 is performed, the training control unit 16 initializes a hidden state storage area 21 (step SA2). The hidden state storage area 21 is a storage area for a hidden state provided in the storage 2.

In a case where step SA3 is performed, the construction unit 12 selects M pieces of sequence data from N pieces of sequence data 41 to construct the mini-batch 42, and outputs sequence information 43 identifying the selected sequence (step SA3).

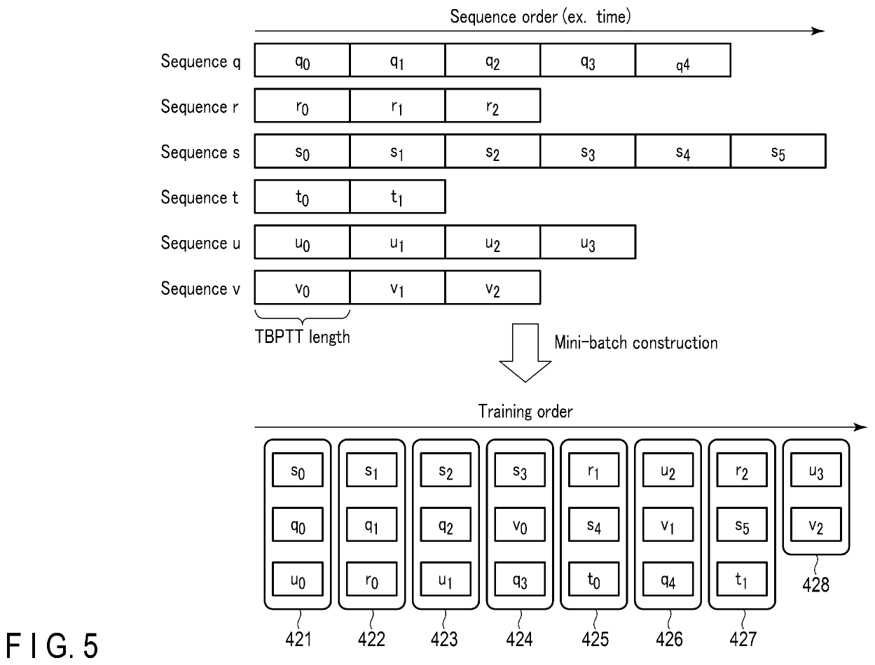

FIG. 5 is a diagram illustrating an example of a mini-batch construction process. In FIG. 5, it is assumed that there are six sequences of s q, r, s, t, u, and v, that is, N=6, and the mini-batch size M is three. Each sequence is divided into a plurality of blocks along a sequence order, and each block has a TBPTT length. For example, when the sequence data is time-series data, the sequence order is time. The number of blocks included in the sequence does not need to be the same, and may be different as illustrated in FIG. 5. For example, the sequence q includes five blocks, but the sequence r includes three blocks. Note that one mini-batch 42m (m is the index of the mini-batch, 1≤m≤8) may be constructed for each step of mini-batch training. Hereinafter, one step of mini-batch training is referred to as a time step.

The construction unit 12 selects 3 blocks from among the 6 pieces of sequence data. The three selected blocks constitute one mini-batch 42m. There are various methods for selecting the three blocks. For example, first, the construction unit 12 randomly selects three pieces of sequence data from among the six pieces of sequence data. As another example, the construction unit 12 may select three pieces of sequence data from the six pieces of sequence data according to a predetermined rule. Next, the construction unit 12 sequentially selects an unprocessed block for each of the selected sequence data. Specifically, the construction unit 12 sequentially selects blocks from a block with an earlier sequence to a block with a later sequence among the unprocessed blocks. For example, as the first mini-batch 421, a block so of the sequence data s, a block q0 of the sequence data q, and a block u1 of the sequence data u are selected.

In a case where a block is selected, the construction unit 12 outputs sequence information of the selected block. For example, in a case where a block so of the sequence data s, a block q0 of the sequence data q, and a block u0 of the sequence data u are selected as the first mini-batch 421, an identifier representing the sequence s, an identifier representing the sequence q, and an identifier representing the sequence u are output. For example, the construction unit 12 may hold the sequence information database, query the sequence information database with the sequence data of the selected block, and output the sequence information corresponding to the block. The sequence information database is a database that systematically associates sequence information for each type of sequence data. The sequence information may include at least an identifier of a sequence.

In a case where step SA3 is performed, the training control unit 16 determines the presence or absence of an unprocessed mini-batch (step SA4). The presence or absence of an unprocessed mini-batch can be determined based on the presence or absence of an unselected block. Specifically, the training control unit 16 determines that there is an unprocessed mini-batch in a case where there is an unselected block, and determines that there is no unprocessed mini-batch in a case where there is no unselected block.

In step SA4, when it is determined that there is an unprocessed mini-batch (step SA4: YES), the reading unit 13 reads unprocessed hidden state 44 from the hidden state storage area 21 according to the sequence information 43 output in step SA3 (step SA5). The hidden state storage area 21 is a storage area provided in the storage 2. The hidden state storage area 21 is secured for each sequence identifier and stores hidden information related to the sequence identifier. The reading unit 13 searches the hidden state storage area 21 using the sequence information 43 as an index, and reads the hidden state (the unprocessed hidden state) from the storage area of the sequence information 43. Since the hidden state is overwritten in the hidden state storage area 21, the latest hidden state for one piece of sequence data, that is, only the hidden state obtained by the previous optimization calculation is stored.

In step SA5, the optimization unit 14 executes optimization calculation based on the mini-batch 42 constructed in step SA3 and the unprocessed hidden state 44 read in step SA5 (step SA6). In the optimization calculation, the optimization unit 14 performs forward propagation calculation, back propagation calculation, and parameter update. In the forward propagation calculation, an input/output of each layer is calculated. In the back propagation calculation, a gradient of an input/output of each calculated layer is calculated. In the parameter update, the parameter is updated based on the calculated gradient. In the forward propagation calculation, the optimization unit 14 calculates a hidden state of the last forward propagation calculation output of the RNN layer (forward propagation calculation output from the n-th RNN). The hidden state is stored in the hidden state storage area 21. Hereinafter, the hidden state is referred to as a processed hidden state. Note that the hidden state obtained by the forward propagation calculation performed after the parameter update may be stored in the hidden state storage area 21 as the “processed hidden state”.

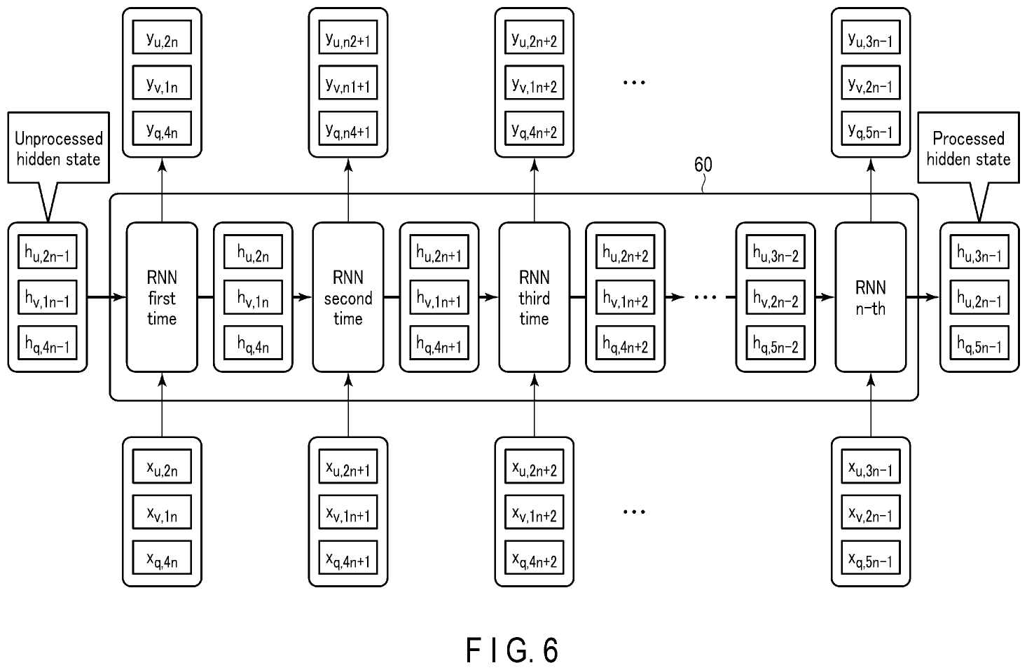

FIG. 6 is a diagram schematically illustrating forward propagation calculation in the optimization calculation. In FIG. 6, the mini-batch size M is 3, and the mini-batch is constructed by a third block u2 of the sequence data u, a second block v1 of the sequence v, and a fifth block v4 of the sequence q. It is assumed that n elements x are included in each block. That is, the TBPTT length is n. The third block u2 of the sequence data u includes n elements from the elements X_{u,2n} to the elements X_{u,3n-1}, the second block v1 of the sequence data v includes n elements from the elements X_{v,1n} to the elements X_{v,2m-1}, and the fifth block q4 of the sequence data q includes n elements from the elements x_{q,4n} to the elements X_{q,5n-1}. The hidden states before processing are represented by h_{u,2n-1}, h_{v,1n-1}, h_{q,4n-1}. The hidden states after processing are represented by h_{u,3n-1}, h_{v,2n-1}, h_{q,5n-1}.

The optimization unit 14 executes forward propagation calculation by recursively applying the hidden states before processing h_{u,2n-1}, h_{v,n-1}, h_{q,4n-1} and the n elements X_{u,2n} to X_{u,3n-1}, the n elements X_{v,1n} to X_{v,2n-1}, and the n elements X_{q,4n} to X_{q,5n-1} to the RNN 60. More specifically, as illustrated in FIG. 6, the optimization unit 14 first applies the hidden states before processing h_{u,2n-1}, h_{v,1n-1}, h_{g,4n-1} and the first elements X_{u,2n}, X_{v,2n}, X_{q,4n} to the first RNN to output the first outputs y_{u,2n}, Y_{v,1n}, Y_{q,4n} and the first intermediate hidden states h_{u,2n}, h_{v,1n}, h_{q,4n}. Next, the optimization unit 14 applies the first intermediate hidden states h_{u,2n}, h_{v,1n}, h_{q,4n} and the next second elements x_{u,2n+1}, x_{v,1n+1}, x_{q,4m+1} to the second RNN to output the second outputs y_{u,2n+1}, y_{v,n+1}, Y_{q,4n+1} and the second intermediate hidden states h_{u,2n+1}, h_{v,1n+1}, h_{q,4n+1}. Thereafter, similarly, it sequentially applies the element in the current time step and the hidden state obtained in the previous time step to the RNN in the current time step to output the output and the hidden state in the current time step. Then, it applies the hidden states h_{u,3n-2}, h_{v,2n-2}, h_{q,5n-2} in the (n−1)-th time step and the n-th elements x_{u,3n-1}, x_{v,2n-1}, x_{q,5n-1} to the n-th RNN to output the n-th outputs y_{u,3n-1}, y_{v,2n-1}, y_{q,5n-1} and the n-th hidden states after processing h_{u,3n-1}, h_{v,2n-1}, h_{q,5n-1}.

In a case where step SA6 is performed, the writing unit 15 writes the processed hidden state 45 obtained by the optimization calculation in step SA6 in the hidden state storage area 21 according to the sequence information 43 output in step SA3 (step SA7). The writing unit 15 searches the hidden state storage area 21 using the sequence information 43 of the sequence data as an index for each of the three pieces of sequence data included in the mini-batch 42 to be processed, and overwrites the storage area of the sequence information 43 with the processed hidden state 45. As a result, the latest hidden state for each piece of the sequence data is stored in the hidden state storage area 21.

In a case where step SA7 is performed, in step SA3 again, the construction unit 12 selects M pieces of sequence data from the unprocessed sequence data 41, constructs the next mini-batch 42, and outputs the next sequence information 43. The read processing (step SA5), the optimization calculation (step SA6), and the write processing (step SA7) are executed for the next mini-batch 42 and/or the next sequence information 43.

In this manner, steps SA3 to SA7 are repeated as described above until it is determined in step SA4 that there is no unprocessed mini-batch 42. As illustrated in FIG. 5, the last mini-batch 428 may have a smaller mini-batch size, that is, a smaller number of blocks included, than the other mini-batches 421 to 427. In this case, the mini-batch 428 may be padded with a predetermined block in order to adjust the number of blocks included in the mini-batch 428 to that of the other mini-batches 421 to 427. In addition, in step SA3 at a stage where it is determined that there is no unprocessed mini-batch 42, the mini-batch 42 is not constructed, and the sequence information 43 is not output.

In step SA4, in a case where it is determined that there is no unprocessed mini-batch 42 (step SA4: NO), the training control unit 16 adds the value “1” to the index i and determines whether the index i is less than an upper limit epoch number TH (step SA8). The upper limit epoch number TH may be set to an any value according to experience or an any algorithm.

When it is determined in step SA8 that the index i is less than the upper limit epoch number TH (step SA8: YES), steps SA1 to SA7 are repeated again for the next epoch until it is determined in step SA4 that there is no unprocessed mini-batch 42.

Then, in a case where it is determined in step SA8 that the index i is equal to or larger than the upper limit epoch number TH (step SA8: NO), the training control unit 16 outputs a trained network parameter 46 (step SA9). The trained network parameters 46 are stored in the storage 2. The trained network parameters 46 are assigned to the RNN, thereby constructing the trained RNN.

As described above, the RNN training processing by the RNN training apparatus 100 ends.

The RNN training processing illustrated in FIGS. 3 and 4 is an example, and various modifications are possible.

Next, a detailed embodiment of the mini-batch initialization process (step SA2) to the mini-batch presence/absence determination process (step SA4) in FIG. 3 will be described.

### Example 1

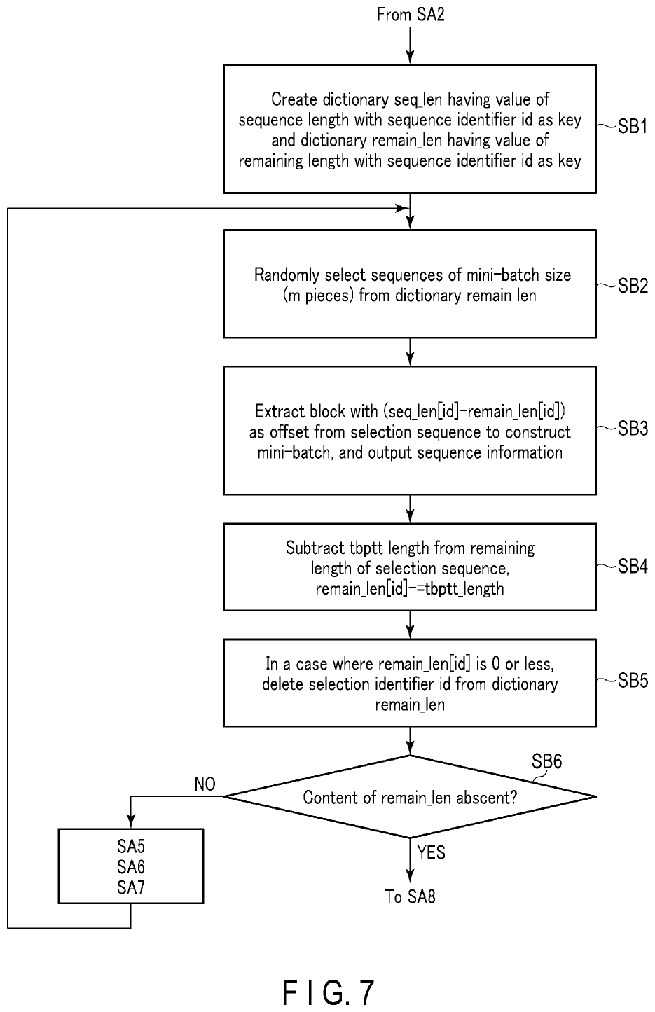

FIG. 7 is a diagram illustrating a processing procedure of Example 1 from the mini-batch initialization process (step SA2) to the mini-batch presence/absence determination process (step SA4) illustrated in FIG. 3. Note that step SB1 is provided between step SA2 and step SA3, steps SB2 to SB3 correspond to step SA3, and steps SB4 to SB6 correspond to step SA4. The construction unit 12 according to Example 1 randomly selects M sequences from among sequences having a remaining length of 1 or more among the N sequences.

As illustrated in FIG. 7, the training control unit 16 creates a dictionary seq_len having a value of a sequence length a with the sequence identifier id as a key and a dictionary remain_len having a value of a remaining length with the sequence identifier id as a key (step SB1). The dictionary seq_len and the dictionary remain_len are created for all sequences.

In a case where step SB1 is performed, the construction unit 12 randomly selects sequences of a mini-batch size (M pieces) from the dictionary remain_len (step SB2). In step SB2, M sequences are randomly selected from sequences having a remaining length of 1 or more among the N sequences.

In a case where step SB2 is performed, the construction unit 12 extracts a block with seq_len[id]−remain_len[id] as an offset from the sequence (selection sequence) selected in step SB2, constructs a mini-batch to output sequence information (step SB3). seq_len[id] is a dictionary of the sequence identifier id that outputs the sequence length of the selection sequence. remain_len[id] is a dictionary of the sequence identifier id that outputs the remaining length of the selection sequence. seq_len[id]-remain_len[id] means the position in the sequence data of the block selected in the current time step.

In a case where step SB3 is performed, the training control unit 16 subtracts the TBPTT length from the remaining length of the selection sequence (step SB4). That is, in step SB4, the training control unit 16 executes remain_len[id]−=TBPTT_length. TBPTT_length represents a TBPTT length.

In a case where step SB4 is performed, the training control unit 16 deletes the selection identifier id from the dictionary remain_len if the remain_len[id] is 0 or less (step SB5). remain_len[id] being 0 or less than means that there is no remaining block in the sequence. In this case, since there is no need to be selected in the remaining time steps, the selection identifier id of the sequence is deleted from the dictionary remain_len.

In a case where step SB5 is performed, the training control unit 16 determines the absence or not (that is presence) of the content of the dictionary remain_len (step SB6). The presence of the content of the dictionary remain_len means that there is a sequence having a remaining block, and the absence of the content of the dictionary remain_len means that there is no sequence having a remaining block.

In step SB6, in a case where it is determined that the content of the dictionary remain_len is present (step SB6: NO), the read processing (step SA5), the optimization calculation (step SA6), and the write processing (step SA7) illustrated in FIG. 3 are executed, and the process returns to step SB2. Then, in step SB6, in a case where it is determined that there is no content in the dictionary remain_len (step SB6: YES), the determination process (step SA8) illustrated in FIG. 3 is performed. Steps SA1 to SA7 are repeated until it is determined that the epoch number (index i) exceeds the upper limit epoch number TH.

This is the end of Example 1.

### Example 2

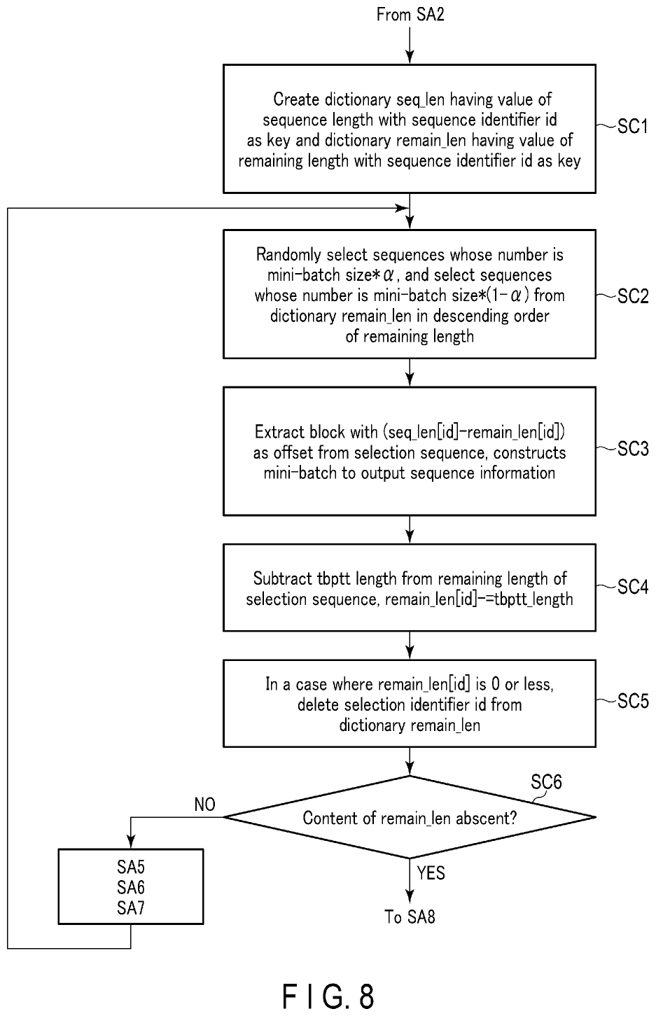

FIG. 8 is a diagram illustrating a processing procedure of Example 1 from the mini-batch initialization process (step SA2) to the mini-batch presence/absence determination process (step SA4) illustrated in FIG. 3. Note that step SC1 is provided between step SA2 and step SA3, steps SC2 to SC3 correspond to step SA3, and steps SC4 to SC6 correspond to step SA4. Steps SC1 and 3 to 6 are the same as steps SB1 and 3 to 6, and thus description thereof is omitted. The construction unit 12 according to Example 2 randomly selects a first sequences whose number corresponds to the product of the number M of mini-batches and the selectivity among the M sequences, and preferentially selects the remaining second sequences by giving priority to a sequence having a large amount of remaining lengths.

As illustrated in FIG. 8, in a case where step SC1 is performed, the construction unit 12 randomly selects sequences whose number is the mini-batch size (M pieces)*α, and selects sequences whose number is the mini-batch size (M pieces)*(1−α) from the dictionary remain_len in descending order of remaining length (step SC2). For the parameter α, is 0<α<1, and it corresponds to a random selectivity ratio. In a case where the variation of the sequence length is large and only a long sequence remains, the padding can be reduced by decreasing α.

This is the end of Example 2.

### Example 3

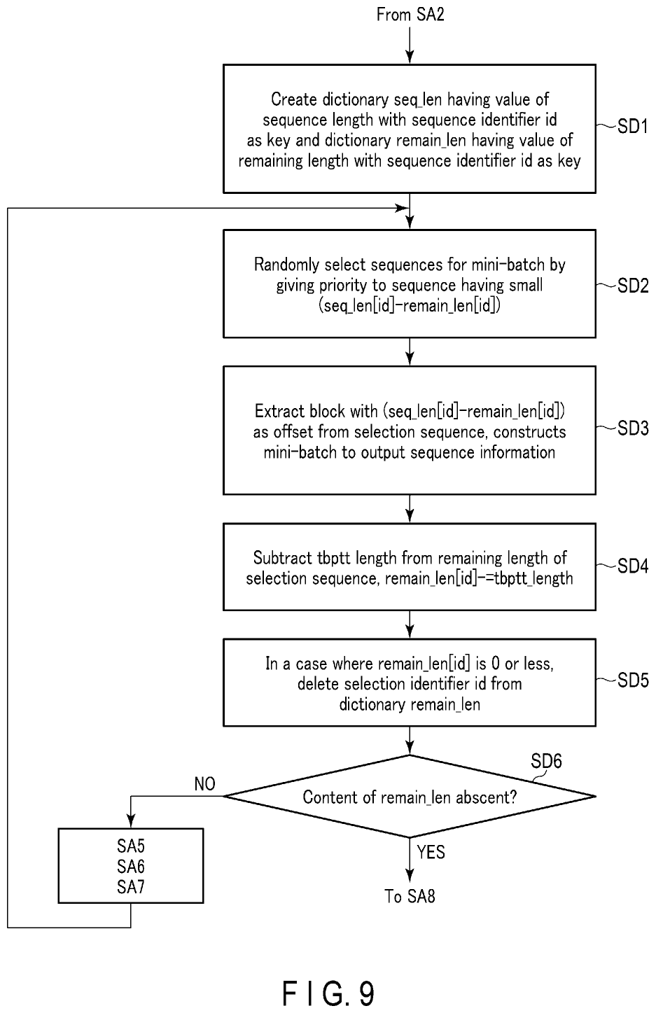

FIG. 9 is a diagram illustrating a processing procedure of Example 3 from the mini-batch initialization process (step SA2) to the mini-batch presence/absence determination process (step SA4) illustrated in FIG. 3. Note that step SD1 is provided between step SA2 and step SA3, steps SD2 to SD3 correspond to step SA3, and steps SD4 to SD6 correspond to step SA4. Steps SCD and 3 to 6 are the same as steps SB1 and 3 to 6, and thus description thereof is omitted. The construction unit 12 according to Example 3 randomly selects M sequences by giving priority to a sequence having a small difference between the sequence length and the remaining length among the N sequences.

As illustrated in FIG. 9, in a case where step SD1 is performed, the construction unit 12 randomly selects sequences for a mini-batch (M pieces) by giving priority to a sequence having a small (seq_len[id]−remain_len[id]) (step SD2). (seq_len[id]−remain_len[id]) means the sequence length of the processed block. As a result, the sequences are uniformly selected over a plurality of sequences, and thus it is possible to select a plurality of sequences so that the offsets of the time steps are aligned.

This is the end of Example 3.

### Effects

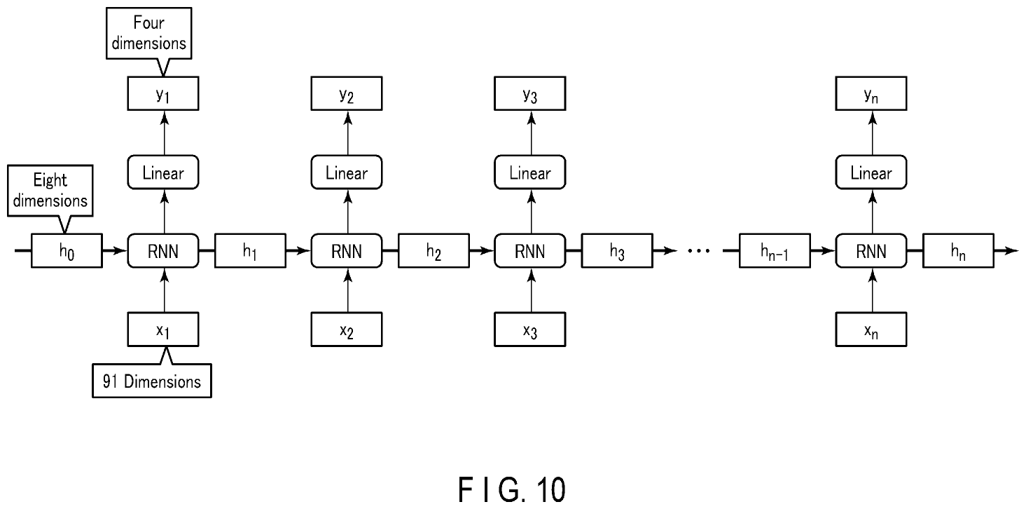

Effects according to the present embodiment will be described with reference to FIGS. 10, 11, and 12. FIG. 10 is a diagram schematically illustrating an RNN used for effect verification according to the present embodiment. As illustrated in FIG. 10, it is assumed that the RNN is a temperature estimation (regression) problem in which an element x which is an input is 91 dimensions, a TBPTT length is 128, a hidden state h is eight dimensions, and an output y is four dimensions. The RNN calculates the hidden state h in the next time step based on the element x and the hidden state h, and calculates the output y by applying a linear transformation layer (Linear) to the hidden state h.

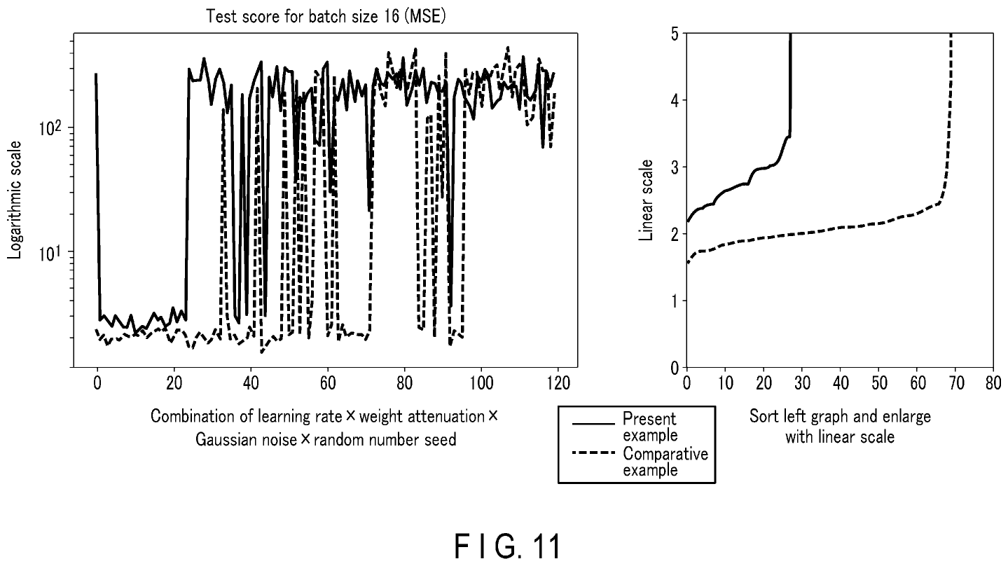

FIG. 11 is a diagram illustrating a test score in a case where the batch size is 16. In the left diagram of FIG. 11, the vertical axis represents a logarithm of a mean squared error (MSE) which is a test score, and the horizontal axis represents a sample number. The MSE is a value obtained by dividing the sum of the squares of the differences between the prediction value and the correct value by the number of pieces of data. The lower the MSE, the better the accuracy of the RNN. The sample number is a number assigned to a combination of the learning rate, the weight attenuation, the Gaussian noise, and the random number seed. The right diagram of FIG. 11 is a graph in which samples are sorted by the value of the MSE. Solid lines in the left and right diagrams of FIG. 11 represent the technique according to the present embodiment, and dotted lines represent the technique according to the comparative example. The technique according to the comparative example means the technique according to Non-Patent Literature 1 (Viacheslav Khomenko, et al. “Accelerating Recurrent Neural Network Training using Sequence Bucketing and Multi-GPU Data Parallelization”), that is, bucketing.

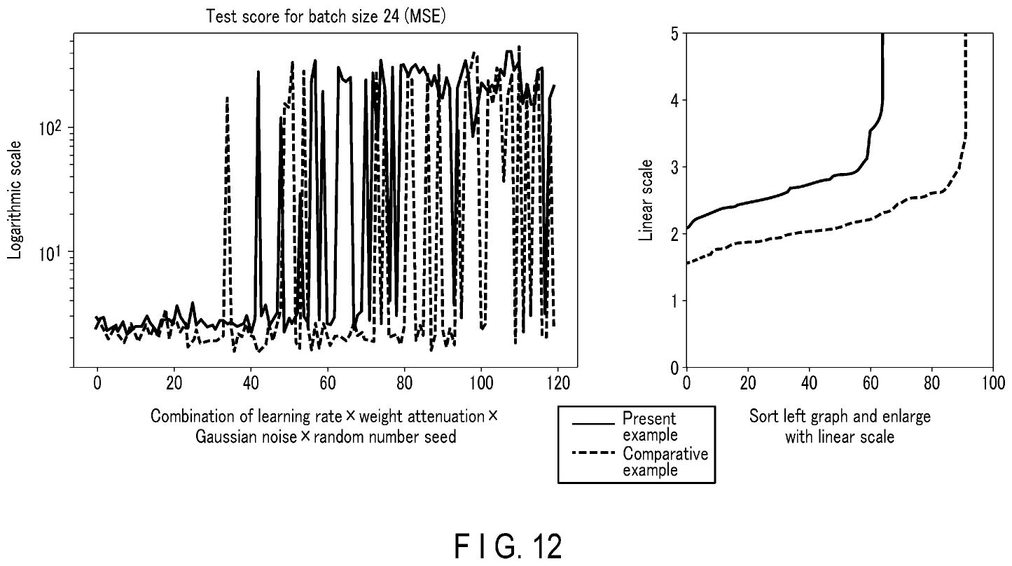

FIG. 12 is a diagram illustrating a test score in a case where the batch size is 24. The vertical axis of the left diagram in FIG. 12 represents a logarithm of the MSE as the test score, and the horizontal axis represents a sample number. The sample number is a number assigned to a combination of the learning rate, the weight attenuation, the Gaussian noise, and the random number seed. The right diagram of FIG. 12 is a graph in which samples are sorted by the value of the MSE. Solid lines in the left and right diagrams of FIG. 12 represent the results of the present embodiment, and dotted lines represent the results of the comparative example.

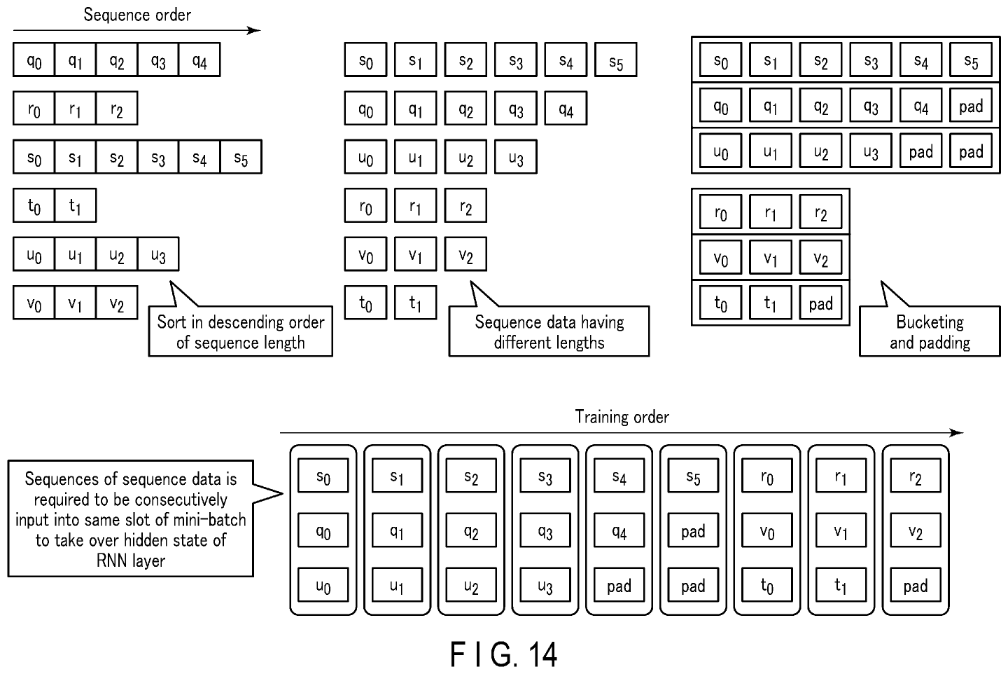

Here, a comparative example will be briefly described with reference to FIG. 14. As illustrated in FIG. 14, as in the present embodiment, in the comparative example, six pieces of sequence data of sequences q, r, s, t, u, and v are prepared, and the sequence lengths of the sequences are the same. The mini-batch size is also assumed to be M=3 as in the present embodiment. In the comparative example, reading and writing of the hidden state are not performed. In the comparative example, six pieces of sequence data are sorted in descending order by sequence length. Bucketing and padding are then performed. That is, the six pieces of sequence data are divided into two buckets having close sequence lengths. Empty blocks for each bucket are padded. Then, three blocks of three pieces of sequence data are selected from the bucket in ascending order of numbers to construct a mini-batch. In the comparative example, since reading and writing of the hidden state are not performed, the hidden state of the RNN is taken over, so that it is necessary to continuously input the block of the sequence data into the same slot of the mini-batch. For this reason, the degree of freedom in selecting the sequence data constituting the mini-batch may be poor, and the convergence of the training may be unstable. In addition, since padding is performed, the number of mini-batches increases, and the training efficiency may deteriorate.

On the other hand, since the RNN training apparatus 100 according to the present embodiment includes the reading unit 13, the writing unit 15, and the hidden state storage area 21, it is possible to read and write the hidden state at any timing. Therefore, in the present embodiment, since padding can be reduced as compared with that in the comparative example, it is possible to reduce a calculation load for a padded block. In addition, since the type of the sequence data or the block can be made different between adjacent mini-batches, in the present embodiment, as compared with that in the comparative example, the bias of the training data is reduced, the convergence of the training is stabilized, and the performance of the finally converged RNN is improved. As illustrated in FIGS. 11 and 12, the MSE of the present embodiment is generally lower than that of the comparative example. Therefore, it can be seen that the accuracy of the RNN in the present embodiment is higher than that in the comparative example.

### Modification

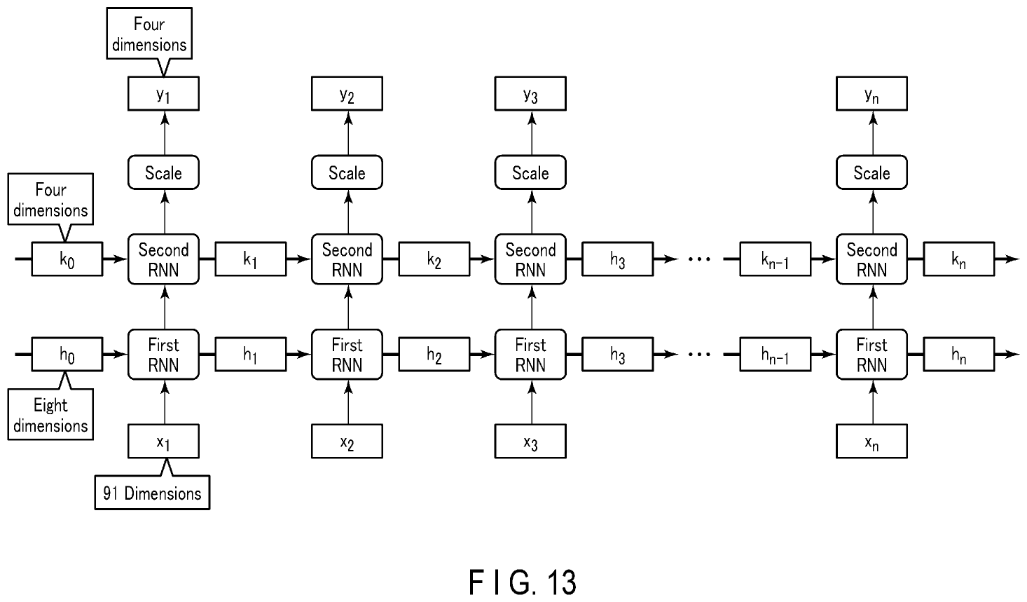

FIG. 13 is a diagram schematically illustrating an RNN according to a modification. As illustrated in FIG. 13, the RNN may have two layers. In this case, a first RNN receives the hidden state h and the 91 dimensional element x to output the intermediate output and the eight dimensional hidden state h. The second RNN receives the intermediate output and the hidden state k to output the intermediate output and the four dimensional hidden state k. The intermediate output is subjected to a scale operation by a scale layer (Scale), and is converted into a four dimensional output y. Note that the number of dimensions of each data is an example, and the present invention is not limited thereto. In addition, the number of layers of the RNN may be three or more. In addition, another network such as a linear conversion layer may be included instead of or in addition to the scale layer.

Thus, according to the present embodiment, it is possible to provide an RNN training apparatus, a method, and a program capable of improving convergence stability and efficiency of training of a recurrent neural network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An RNN training apparatus comprising:
a storage that stores a hidden state that is intermediate output data of a recurrent neural network for N sequences; and
a processing circuitry that
constructs a mini-batch by selecting data of M sequences from data of N sequences used for training of the recurrent neural network where M is smaller than N, and outputs sequence information identifying the selected sequence,
reads an unprocessed hidden state of a sequence corresponding to the sequence information from the storage according to the sequence information,
executes optimization calculation of the recurrent neural network based on the unprocessed hidden state and the mini-batch, and
writes a processed hidden state in the storage according to the sequence information, the processed hidden state being intermediate output data of the recurrent neural network obtained by the optimization calculation.

2. The RNN training apparatus according to claim 1, wherein the processing circuitry randomly selects the M sequences from the N sequences.

3. The RNN training apparatus according to claim 2, wherein the processing circuitry randomly selects the M sequences from among sequences having one or more remaining lengths among the N sequences.

4. The RNN training apparatus according to claim 3, wherein the processing circuitry randomly selects first sequences whose number corresponds to a product of the number of mini-batches and a selectivity among the M sequences, and preferentially selects remaining second sequences by giving priority to a sequence having a large amount of remaining lengths.

5. The RNN training apparatus according to claim 1, wherein the processing circuitry randomly selects the M sequences by giving priority to a sequence having a small difference between a sequence length and a remaining length among the N sequences.

6. The RNN training apparatus according to claim 1, wherein data of each of the N sequences is divided into blocks having a common TBPTT length.

7. The RNN training apparatus according to claim 6, wherein in a case of selecting data of the M sequences for each of the M sequences, the processing circuitry sequentially selects an unprocessed block among blocks of the selected sequence.

8. The RNN training apparatus according to claim 1, wherein the processing circuitry performs forward propagation calculation, back propagation calculation, and parameter update in the optimization calculation, and calculates the hidden state in the forward propagation calculation and/or the back propagation calculation.

9. The RNN training apparatus according to claim 1, wherein the sequence information has an identifier of the selected sequence.

10. The RNN training apparatus according to claim 1, wherein the processing circuitry overwrites the unprocessed hidden state with the processed hidden state.

11. An RNN training method comprising:
constructing a mini-batch by selecting data of M sequences from data of N sequences used for training of a recurrent neural network where M is smaller than N, and outputting sequence information identifying the selected sequence;
reading an unprocessed hidden state of a sequence corresponding to the sequence information from a storage according to the sequence information;
executing optimization calculation of the recurrent neural network based on the unprocessed hidden state and the mini-batch; and
writing a processed hidden state in the storage according to the sequence information, the processed hidden state being intermediate output data of the recurrent neural network obtained by the optimization calculation.

12. A non-transitory computer readable medium including computer executable instructions, wherein the instructions, when executed by a processor, cause the processor to perform operations comprising:
constructing a mini-batch by selecting data of M sequences from data of N sequences used for training of a recurrent neural network where M is smaller than N, and outputting sequence information identifying the selected sequence;
reading an unprocessed hidden state of a sequence corresponding to the sequence information from a storage according to the sequence information;
executing optimization calculation of the recurrent neural network based on the unprocessed hidden state and the mini-batch; and
writing a processed hidden state in the storage according to the sequence information, the processed hidden state being intermediate output data of the recurrent neural network obtained by the optimization calculation.
